(19) United States
(12) Patent Application Publication
(10) Pub. No.: US 2003/0010325 A1
(43) Pub. Date: Jan. 16, 2003

(54) Method and device for the control of a fuel injection valve

(76) Inventors: Rolf Reischl, Stuttgart (DE); Andreas Eichendorf, Schorndorf (DE); Ulf Pischke, Stuttgart (DE); Juergen Eckhardt, Markgroeningen (DE); Klaus Mueller, Asperg (DE)

Correspondence Address: KENYON & KENYON, ONE BROADWAY, NEW YORK, NY, 10004, US

(21) Appl. No.: 09/979,353

(22) PCT Filed: Sep. 2, 2001
(86) PCT No.: PCT/DE01/00499

(30) Foreign Application Priority Data
Mar. 22, 2000 (DE) 100 14 228.1

(51) Int. Cl. F02D 41/20

(52) U.S. Cl. 123/490; 361/154

(57) ABSTRACT

The present invention relates to a method and a device for triggering a solenoid valve for injecting fuel into an internal combustion engine, the triggering phase of the solenoid valve being subdivided into a pull-up phase (T_{A}), during which a valve needle of the solenoid valve is caused to open by a first current intensity (I_{A}) flowing through a magnetic coil of the solenoid valve, and into a holding phase (T_{H}) during which the valve needle is held in the open state by a second, lower current intensity (I_{H}) flowing through the magnetic coil, and at least once at the beginning of the pull-up phase (T_{A}), a booster phase (B₁) being activated during which a pulse-shaped booster current (I_{BOOST}) from a booster capacitor charged to a high voltage (U_{BOOST}) flows through the magnetic coil; and is characterized in that during the triggering phase of the solenoid valve, a plurality of booster pulses (B₁, B₂₁, B₂₂) are activated in succession, whose time position within the triggering phase is freely selectable (FIGS. 3A-3C).

### BACKGROUND INFORMATION

The present invention relates to a method and a device for triggering a solenoid valve, particularly for injecting fuel into an internal combustion engine, the triggering phase of the solenoid valve being subdivided into a pull-up phase, during which a valve needle of the solenoid valve is caused to open by a first current intensity flowing through a magnetic coil of the solenoid valve, and into a holding phase during which the valve needle is held in the open state by a second, lower current intensity flowing through the magnetic coil, and at least once at the beginning of the pull-up phase, a booster phase being activated during which a pulse-shaped booster current from a booster capacitor charged to a high voltage or from another current source flows through the magnetic coil.

Such a method and such a device are known from the German patent 197 46 980 A1 of Robert Bosch GmbH.

The attached FIGS. 1 and 2 show, in the form of signal diagrams, the characteristic of the voltage and of the current at and through, respectively, a magnetic coil of an injector during a triggering phase composed of a pull-up phase T_{A} and a holding phase T_{H}, and specifically, FIG. 1 for the case when the supply battery has a normal voltage level, e.g. U_{BATT}=14 V, and FIG. 2 for the case when the supply battery has too low a voltage level of less than, for example, 14 V.

According to FIG. 1, after the initial current maximum I_{BOOST}, caused by a first booster phase B₁ with great booster voltage U_{BOOST}, the current reaches a pull-up current level I_{A} by which the valve needle of the solenoid valve is able to pull up. It is clear that booster voltage U_{BOOST}, which is impressed on the solenoid valve during booster phase B₁, is much greater than battery voltage U₁. During pull-up phase T_{A}, pull-up current level I_{A} is regulated by repeatedly impressing battery voltage U_{BATT} on the magnetic coil. Pull-up phase T_{A} is followed initially by a brief free-running phase or a rapid extinction, during which the current through the magnetic coil of the injector decreases very rapidly and a holding-current level I_{H} is reached which, during holding phase T_{H}, is regulated to a setpoint level by repeated pulse-shaped impressing of battery voltage U_{BATT}. At the end, following holding phase T_{H}, there is again a free-running phase or rapid extinction, at whose end the current through the magnetic coil is completely decayed.

FIG. 2 now shows the case when the valve needle is unable to pull up during pull-up phase T_{A} because of too low a battery voltage U_{BATT2} (FIG. 2)<U_{BATT} (FIG. 1). Thus, particularly at low battery voltage accompanied by a given ohmic resistance in the circuit, sufficient pull-up current for the solenoid injection valve cannot be built up. That is to say, (I<I_{A}) FIG. 2 shows that current I through the magnetic coil falls off very rapidly and the regulating range of the pull-up current regulation is not reached, and therefore reliable opening of the solenoid valve is no longer ensured.

In order to achieve good dynamic response of the valve, the level of the current through the injector should remain at a high level as much as possible during the entire opening movement of the valve needle in pull-up phase T_{A}. Because of the high withdrawal of energy from the internal booster capacitor, a theoretically conceivable, long booster phase producing this high current level over the entire pull-up phase is not sensible. In realistic applications, the booster phase is used to achieve a high current level as quickly as possible, a large portion of the booster energy being converted into eddy currents at the beginning of pull-up phase T_{A}. Even before the valve needle is completely open, in the related art, under certain operating conditions, booster phase B₁ is broken off, the valve current is driven from the battery, and decreases. That means that during the actual flight phase, which is the phase during which the valve needle moves, the magnetic force has already fallen again from its maximum value. This means a poor dynamic response of the solenoid valve.

### OBJECTIVES AND ADVANTAGES OF THE INVENTION

In view of the disadvantages of the related art described above, the general objective of the invention is to utilize the booster energy economically and, in addition, to improve the switch-on performance of the valve, even given a small battery voltage.

According to one essential aspect of the invention, this objective is achieved by activating a plurality of booster pulses in succession during the triggering phase of the solenoid valve. In principle, their time position within the triggering phase is freely selectable.

Thus, in a first exemplary embodiment of the present invention, after the first booster pulse is activated at the beginning of the pull-up phase, a further booster pulse can be activated still prior to or during the flight phase of the valve needle.

According to a second exemplary embodiment, after the first booster pulse is activated at the beginning of the pull-up phase, a further booster pulse can be activated at the end or immediately after the flight phase of the valve needle.

Finally, according to a third exemplary embodiment, a further booster pulse or a plurality of further booster pulses can be activated during the holding phase of the solenoid valve, if the voltage of the supply battery lies below a specific threshold voltage during this holding phase.

The exemplary embodiments of the present invention described above can also be combined with one another.

The energy or the maximum current of the individual booster pulses can be reduced by the repeated boosting compared to one long single boosting with a very high current intensity. A reduced peak current intensity brings with it a lower load of the bonding pads for integrated circuits, of hybrid assemblies, and a smaller storage capacitance of the booster capacitor.

By suitable selection of the moments for the second and possibly third booster pulse, the buildup of the magnetic force can be freely varied timewise. This leads to a decrease in the eddy-current formation, and the booster energy can be supplied depending on the need of the solenoid valve as a function of time. In this manner, the pull-away of the valve needle of the solenoid valve from the lower limit-stop point can be supported, the needle flight can be accelerated, and stop bounces at the upper limit stop of the valve needle can be suppressed.

Furthermore, given too low a battery voltage which does not suffice to drive a sufficiently high current through the high-pressure injector, the current level can nevertheless be raised by the multiple boosting, and thus reliable operation of the high-pressure solenoid injection valve can be ensured.

### BRIEF DESCRIPTION OF THE DRAWING

In the following, exemplary embodiments of the present invention are explained in greater detail with reference to the Drawing.

FIG. 1 shows graphically, in the form of a signal-time diagram, the customary characteristic of the current and the voltage, already described, through and at, respectively, a magnetic coil of an injector in the case of single boosting;

FIG. 2 shows graphically the case, likewise already described, when, working with the known method having single boosting, the battery voltage becomes too small;

FIG. 3A shows graphically, in the form of a signal-time diagram, the current characteristic through a magnetic coil according to a first exemplary embodiment of the method of the present invention with double boosting;

FIG. 3B shows graphically the excursion of a valve needle during the triggering phase of a high-pressure solenoid injection valve; and

FIG. 3C shows graphically the current and voltage characteristic over time of a second exemplary embodiment of the invention with triple boosting.

### EXEMPLARY EMBODIMENTS

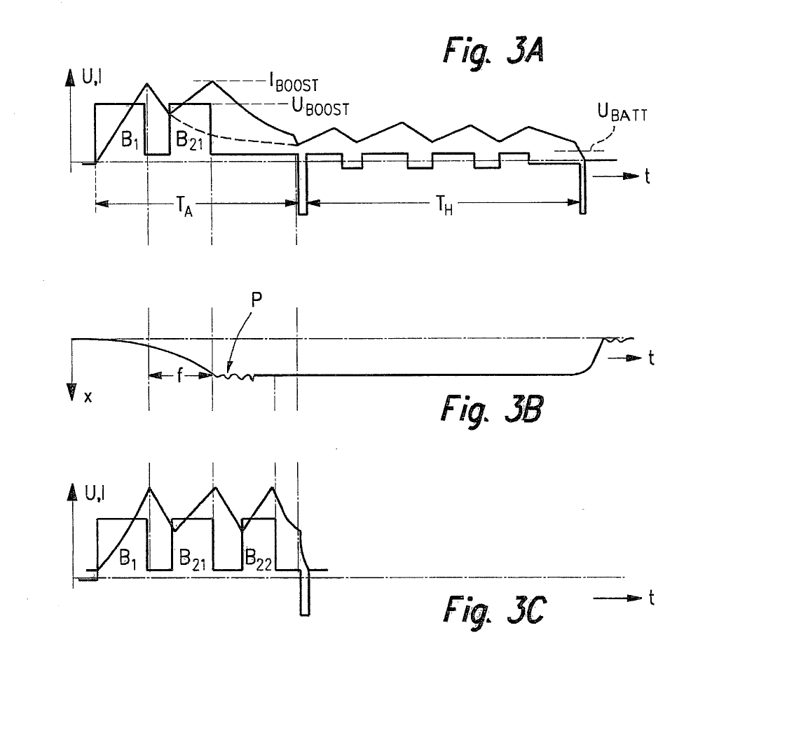

The graphic representation in FIG. 3a shows a first exemplary embodiment of the method according to the present invention in which, given a relatively low battery voltage U_{BATT}, a double boosting takes place. That is to say, after first booster pulse B₁ is activated at the beginning of pull-up phase T_{A}, a further booster pulse B₂₁ is activated which, as a comparison with FIG. 3B showing excursion X of the valve needle immediately makes clear, takes place during flight phase f of the valve needle. The drop of the current through the magnetic coil, indicated by a dotted line in FIG. 3A, is thereby avoided, so that the regulating range of the pull-up current regulation is reached in spite of low battery voltage U_{BATT}, and reliable opening of the valve is ensured. Thus, even given low battery voltage U_{BATT}, the current level can be held up during pull-up phase T_{A} by the double boosting, and the valve can thereby be reliably opened.

FIG. 3C shows a second exemplary embodiment of the triggering method according to the present invention, in which immediately after the flight phase, after second booster pulse B₂₁, a third booster pulse B₂₂ is activated which suppresses bounce p of the valve needle at the upper limit stop.

According to a further exemplary embodiment not shown in the Figure, a further booster pulse or a plurality of further booster pulses can be activated during holding phase T_{H}, in the event holding current I_{H} can no longer be procured from the battery because of a high ohmic resistance in the circuit.

The triggering method shown in the Figure is preferably carried out by a device for triggering a solenoid valve for injecting fuel into an internal combustion engine, which subdivides the triggering phase of the solenoid valve into a pull-up phase, during which a valve needle of the solenoid valve is caused to open by a first current intensity flowing through a magnetic coil of the solenoid valve, and into a holding phase during which the valve needle is held in the open state by a second, lower current intensity flowing through the magnetic coil, and which activates a booster phase at least once at the beginning of the pull-up phase and, in so doing, allows a pulse-shaped booster current from a booster capacitor charged to a high voltage or from another current source to flow through the magnetic coil, the device having means for activating a plurality of booster pulses at selectable moments within the triggering phase of the solenoid valve.

These activation means can be connected to measuring means for measuring at least pull-up current intensity I_{A}, holding current intensity I_{H}, battery voltage U_{BATT} of the supply battery, booster voltage U_{BOOST} and booster current intensity I_{BOOST}.

Therefore, in addition to safeguarding the operation of a high-pressure injector at low battery voltage by activating a plurality of booster pulses and thereby raising the current level, thus ensuring that the high-pressure injector is reliably opened or held open, the method of the present invention permits an economical and variable utilization of the booster energy, in that the eddy-current formation is reduced by the multiple boosting, and booster energy is made available depending on the need as a function of time. In this manner, the pull-away of the valve needle from its lower limit-stop point can be supported, the needle flight can be accelerated, and stop bounces at the upper limit stop of the valve needle can be suppressed.

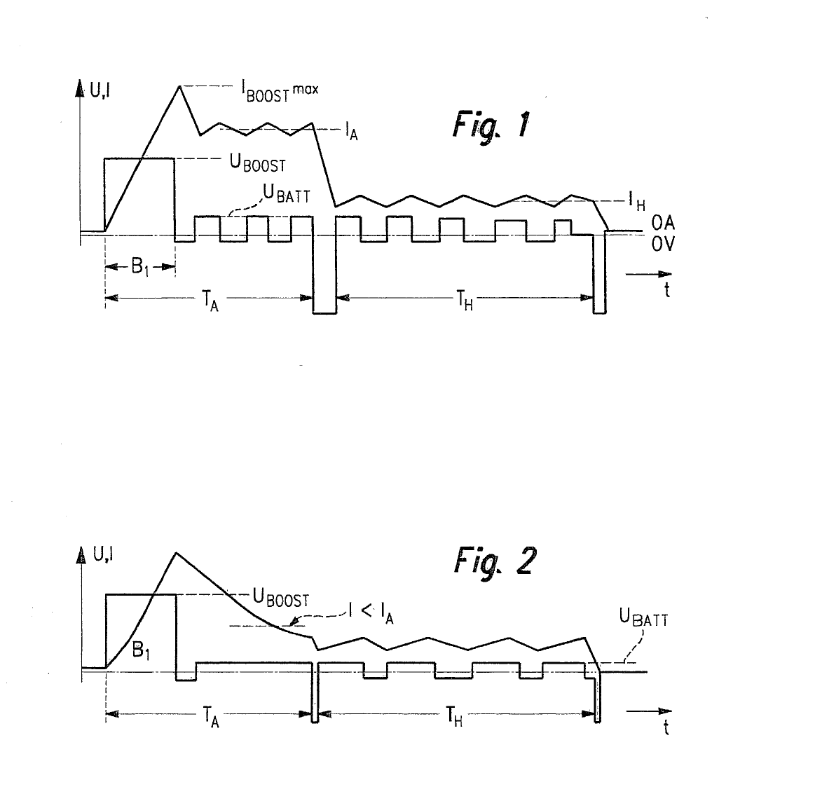

The energy or the maximum current of the single booster pulse can be reduced by the repeated boosting, as a comparison of FIGS. 1 and 2 illustrating the conventional single boosting shows. In this manner, the peak load of the bonding pads for the integrated circuits and of the hybrid assemblies, and the storage capacitance of the booster capacitor can be reduced.

What is claimed is:

1. A method for triggering a solenoid valve, particularly for injecting fuel into an internal combustion engine, the triggering phase of the solenoid valve being subdivided into a pull-up phase (T_{A}), during which a valve needle of the solenoid valve is caused to open by a first current intensity (I_{A}) flowing through a magnetic coil of the solenoid valve, and into a holding phase (T_{H}) during which the valve needle is held in the open state by a second, lower current intensity (I_{H}) flowing through the magnetic coil, and at least once at the beginning of the pull-up phase (T_{A}), a booster phase (B₁) being activated during which a pulse-shaped booster current (I_{BOOST}) from a booster capacitor charged to a high-voltage (U_{BOOST}) or from another current source flows through the magnetic coil, wherein during the triggering phase of the solenoid valve, a plurality of booster pulses (B₁, B₂₁, B₂₂) are activated in succession, whose time position within the triggering phase is freely selectable.

2. The triggering method as recited in claim 1, wherein after the first booster pulse (B₁) activated at the beginning of the pull-up phase (T_{A}), a further booster pulse (B₂₁) is activated still before the beginning or during the flight phase of the valve needle.

3. The triggering method as recited in claim 1 or 2, wherein after the first booster pulse (B₁) activated at the beginning of the pull-up phase (T_{A}), a further booster pulse (B₂₂) is activated at the end or immediately after the flight phase of the valve needle.

4. The triggering method as recited in one of the preceding claims, wherein a further booster pulse or a plurality of booster pulses is/are activated during the holding phase (T_{H}) of the solenoid valve, if the voltage (U_{BATT}) of the supply battery lies below a specific threshold voltage during this phase.

5. A device for triggering a solenoid valve, particularly for injecting fuel into an internal combustion engine, which subdivides the triggering phase of the solenoid valve into a pull-up phase (T_{A}), during which a valve needle of the solenoid valve is caused to open by a first current intensity (I_{A}) flowing through a magnetic coil of the solenoid valve, and into a holding phase (T_{H}) during which the valve needle is held in the open state by a second, lower current intensity (I_{H}) flowing through the magnetic coil, and which at least once at the beginning of the pull-up phase (T_{A}), activates a booster phase (B₁) and, in so doing, allows a pulse-shaped booster current (I_{BOOST}) from a booster capacitor charged to a high voltage (U_{BOOST}) or from another current source to flow through the magnetic coil, wherein the device has means for activating a plurality of booster pulses (B₁, B₂₁, B₂₂) at selectable moments within the triggering phase of the solenoid valve.

6. The device as recited in claim 5, wherein the activation means are connected to measuring means for measuring at least
the pull-up current intensity (I_{A}),
the holding current intensity (I_{H}),
the battery voltage (U_{BATT}) of a supply battery,
the booster voltage (U_{BOOST}), and
the booster current intensity (I_{BOOST}).

7. Use of the method as recited in one of claims 1 through 4 for a high-pressure solenoid injection valve in gasoline direct injection.
